(19) United States
(12) Patent Application Publication
(10) Pub. No.: US 2026/0066833 A1
(43) Pub. Date: Mar. 5, 2026

(54) METHOD FOR CALIBRATING CONSTANT TORQUE OF ELECTRONICALLY COMMUTATED MOTOR

(71) Applicant: Zhongshan Broad-Ocean Motor Co., Ltd., Zhongshan (CN)

(72) Inventors: Xiansheng ZHANG, Zhongshan (CN); Jizhong WANG, Zhongshan (CN); Wei LEI, Zhongshan (CN); Xue LI, Zhongshan (CN)

(21) Appl. No.: 19/383,726

(22) Filed: Nov. 9, 2025

Related U.S. Application Data
(63) Continuation-in-part of application No. PCT/CN2024/121061, filed on Sep. 25, 2024.

(30) Foreign Application Priority Data
Feb. 1, 2024 (CN) 202410147688.X

(51) Int. Cl. H02P 31/00

(52) U.S. Cl. CPC H02P 31/00; H02P 2205/05

(57) ABSTRACT

A method for calibrating constant torque of an ECM motor. The method is applied to replacing a legacy motor with a new motor. The method includes: a) selecting m torque reference points based on torque values of the legacy motor to form a desired torque value array LUT_X[m], where m is an integer≥3; b) based on an actual torque of the new motor, identifying m torque adjustment points, where torque values of the torque adjustment points have a one-to-one correspondence with torque values of the torque reference points, to form a new target torque value array LUT_Y[m]; and c) receiving an externally input target torque T0, invoking a linear interpolation module function associated with the desired torque value array LUT_X[m] and the new target torque value array LUT_Y[m] to obtain a corresponding new torque target value T1, and allowing the new motor to operate under T1.

### CROSS-REFERENCE TO RELATED APPLICATIONS

This application is a continuation-in-part of International Patent Application No. PCT/CN2024/121061 with an international filing date of Sep. 25, 2024, designating the United States, now pending, further claims foreign priority benefits to Chinese Patent Application No. 202410147688.X filed Feb. 1, 2024. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to a method for calibrating constant torque of an electronically commutated motor (ECM).

Early-generation constant torque-controlled ECM motors, developed by leading international HVAC manufacturers, have been widely deployed in the market for many years. There now exists a need to replace these legacy motors with new ones from different manufacturers or incorporating new motor technologies (e.g., copper wire vs. aluminum wire). A critical requirement for such replacements is that the constant torque performance of the new ECM motors must substantially match that of the original motors supplied by the first (or primary) supplier.

However, achieving consistent performance across ECM motors from different manufacturers presents significant technical challenges. Variations in motor material properties, drive hardware, software control algorithms, and manufacturing processes inevitably lead to substantial disparities in motor performance. This is particularly critical for constant torque applications—a mainstream requirement in foreign HVAC equipment, often governed by current control—where stringent tolerances for component parts are essential. Consequently, it is exceedingly difficult to make the constant torque curve of a new motor perfectly align with that of the legacy motor it is intended to replace.

Regarding the background technology for constant torque control of ECM motors, reference may be made to the following prior Chinese patent applications, including: Patent Application No. CN201310518422, titled “A Constant Torque Control Method for an ECM Motor”; Patent Application No. CN201510079416, titled “A Constant Torque Control Method for an ECM Motor”; Patent Application No. CN201811334775, titled “A Constant Torque Control Method Based on Sensorless Vector Control for a Permanent Magnet Synchronous Motor”; and Patent Application No. CN202210365015, titled “A Constant Torque Control Method for an ECM Motor Applied in a Fan System.”

Numerous algorithms exist for constant torque control of ECM motors. However, disparities in motor material characteristics, drive hardware, software algorithms, and manufacturing processes lead to significant variations in motor performance. A pressing technical problem is how to meet customer requirements wherein a new constant torque-controlled ECM motor must replace the original motor from a first supplier while ensuring substantially consistent performance.

Currently, the common approach involves a secondary development process. This entails re-engineering a specific constant torque-controlled ECM motor for a particular fan system to emulate its constant torque performance. However, this method generally fails to achieve performance that substantially overlaps with that of the original ECM motor. Furthermore, the process results in extended project development timelines and increased research and development costs.

### SUMMARY

The disclosure provides a method for calibrating constant torque of an electronically commutated motor (ECM), the method being applied to replacing a legacy motor with a new motor, both the new motor and the legacy motor being constant torque-controlled ECMs, and the method comprising:
a) selecting m torque reference points based on torque values of the legacy motor to form a desired torque value array LUT_X[m], where m≥3, LUT_X[1] is a minimum torque value of the legacy motor, LUT_X[max(m)] is a maximum torque value of the legacy motor, m is an integer, and max(m) is a maximum value of m;
b) based on an actual torque of the new motor, identifying m torque adjustment points, wherein torque values of the torque adjustment points have a one-to-one correspondence with torque values of the torque reference points, to form a new target torque value array LUT_Y[m]; and
c) receiving an externally input target torque T0, invoking a linear interpolation module function associated with the desired torque value array LUT_X[m] and the new target torque value array LUT_Y[m] to obtain a corresponding new torque target value T1, and allowing the new motor to operate under constant torque control using the new torque target value T1.

In a class of this embodiment, in c), the linear interpolation module function employs a piecewise interpolation method comprising:
c1) receiving the externally input target torque T0, comparing T0 with the torque values of the torque adjustment points, and identifying two torque adjustment points a and a+1 closest to T0, wherein a torque value of point a<T0<a torque value of point a+1, and a is an integer; and
c2) invoking the linear interpolation module function comprising LUT_Y[a], LUT_Y[a+1], LUT_X[a], and LUT_X[a+1] to obtain the new torque target value T1, and adjusting the new motor to operate at the new torque target value T1.

In a class of this embodiment, the linear interpolation module function comprising LUT_Y[a], LUT_Y[a+1], LUT_X[a], and LUT_X[a+1] is T1=LUT_Y[a]+(LUT_Y[a+1]−LUT_Y[a])/(LUT_X[a+1]−LUT_X[a]).

In a class of this embodiment, in b), the torque value of each torque adjustment point is adjusted via an experimental method such that the torque value of each torque adjustment point equals the torque value of its corresponding torque reference point, to form the new target torque value array LUT_Y[m].

In a class of this embodiment, adjusting the torque value of each torque adjustment point is achieved by adjusting current and rotational speed parameters for that point.

In a class of this embodiment, in a), when m is an odd number, the torque value of LUT_X[median(m)] is set to be half of a rated torque value of the legacy motor, and median(m) refers to a median value from 1 to m.

In a class of this embodiment, in a), the differences in torque values between every two adjacent torque reference points among the m torque reference points are equal.

The following advantages are associated with the method for calibrating constant torque of an electronically commutated motor of the disclosure.

The method for calibrating constant torque of an electronically commutated motor comprises: a) selecting m torque reference points based on torque values of the legacy motor to form a desired torque value array LUT_X[m], where m≥3, LUT_X[1] is a minimum torque value of the legacy motor, LUT_X[max(m)] is a maximum torque value of the legacy motor, m is an integer, and max(m) is a maximum value of m; b) based on an actual torque of the new motor, identifying m torque adjustment points, wherein torque values of the torque adjustment points have a one-to-one correspondence with torque values of the torque reference points, to form a new target torque value array LUT_Y[m]; and c) receiving an externally input target torque T0, invoking a linear interpolation module function associated with the desired torque value array LUT_X[m] and the new target torque value array LUT_Y[m] to obtain a corresponding new torque target value T1, and allowing the new motor to operate under constant torque control using the new torque target value T1. The software-based algorithmic process ensures that the constant torque performance of the new ECM motor substantially matches that of the legacy ECM motor it replaces. Consequently, the method reduces the need for customers to conduct dual-source motor development testing, shortens the project development cycle, and lowers manufacturing costs.

When multiple loads utilize the same model of constant torque-controlled ECM motor, calibration can be performed by directly inputting the original input target torque value T0. This approach necessitates characterization of only a limited number of loads operating at extreme torque values, thereby significantly reducing the number of development projects required and conserving research and development costs.

### BRIEF DESCRIPTION OF THE DRAWINGS

FIG. 1 is a flow chart of a method for calibrating constant torque of an electronically commutated motor according to one embodiment the disclosure; and

FIG. 2 is a schematic diagram of an experiment according to one embodiment the disclosure.

### DETAILED DESCRIPTION

To further illustrate the disclosure, embodiments detailing a method for calibrating constant torque of an electronically commutated motor are described below. It should be noted that the following embodiments are intended to describe and not to limit the disclosure.

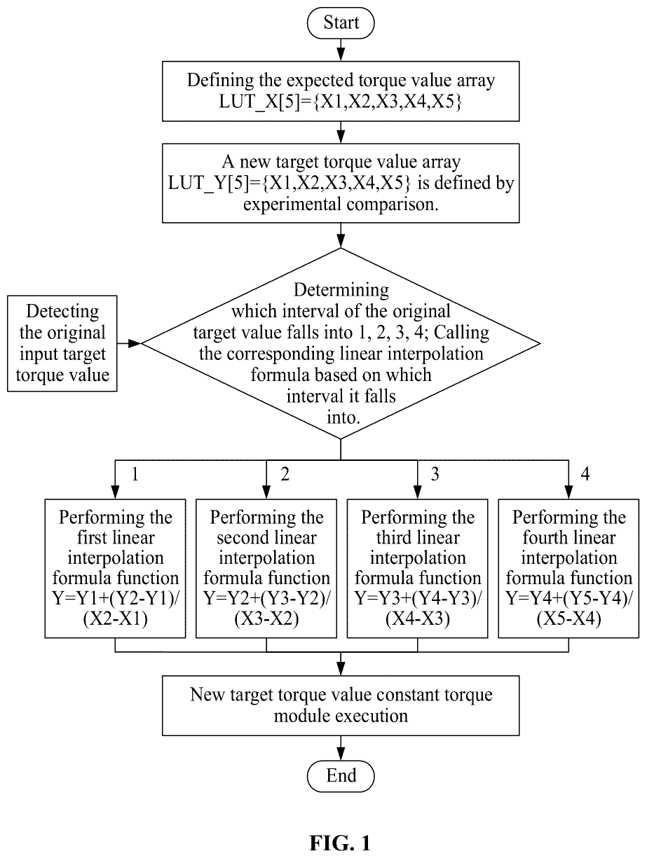

As shown in FIG. 1, the disclosure provides a method for calibrating constant torque of an electronically commutated motor (ECM); the method is applied to replacing a legacy motor with a new motor, and both the new motor and the legacy motor are constant torque-controlled ECMs. The method comprises:
a) selecting m torque reference points based on torque values of the legacy motor to form a desired torque value array LUT_X[m], where m≥3, LUT_X[1] is a minimum torque value of the legacy motor, LUT_X[max(m)] is a maximum torque value of the legacy motor, m is an integer, and max(m) is a maximum value of m;
b) based on an actual torque of the new motor, identifying m torque adjustment points, wherein torque values of the torque adjustment points have a one-to-one correspondence with torque values of the torque reference points, to form a new target torque value array LUT_Y[m]; and
c) receiving an externally input target torque T0, invoking a linear interpolation module function associated with the desired torque value array LUT_X[m] and the new target torque value array LUT_Y[m] to obtain a corresponding new torque target value T1, and allowing the new motor to operate under constant torque control using the new torque target value T1.

In c), the linear interpolation module function employs a piecewise interpolation method comprising:
c1) receiving the externally input target torque T0, comparing T0 with the torque values of the torque adjustment points, and identifying two torque adjustment points a and a+1 closest to T0, wherein a torque value of point a<T0<a torque value of point a+1, and a is an integer; and
c2) invoking the linear interpolation module function comprising LUT_Y[a], LUT_Y[a+1], LUT_X[a], and LUT_X[a+1] to obtain the new torque target value T1, and adjusting the new motor to operate at the new torque target value T1.

The linear interpolation module function comprising LUT_Y[a], LUT_Y[a+1], LUT_X[a], and LUT_X[a+1] is T1=LUT_Y[a]+(LUT_Y[a+1]−LUT_Y[a])/(LUT_X[a+1]−LUT_X[a]).

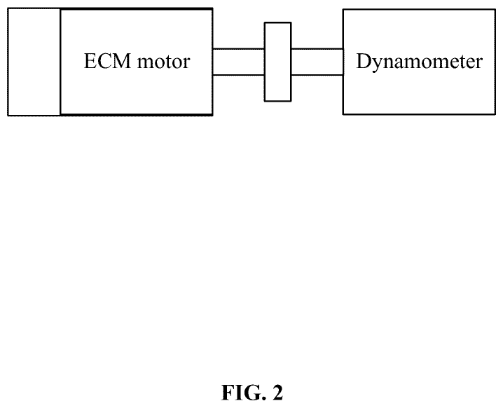

In b), the torque value of each torque adjustment point is adjusted via an experimental method such that the torque value of each torque adjustment point equals the torque value of its corresponding torque reference point, to form the new target torque value array LUT_Y[m]. In one embodiment, the experimental method is performed by connecting the new motor to a motor test bench. The desired torque value array LUT_X[m] is used as the baseline data for the test bench. The new target torque value array LUT_Y[m] for the new motor is then determined through testing, as schematically illustrated in FIG. 2.

Specifically, adjusting the torque value of each torque adjustment point is achieved by adjusting current and rotational speed parameters for that point.

In a), when m is an odd number, the torque value of LUT_X[median(m)] is set to be half of a rated torque value of the legacy motor, and median(m) refers to a median value from 1 to m, that is, median(m)=(m+1)/2.

The principle of the method of the disclosure is to utilize a linear interpolation function to replace complex torque calculation formulas. Specifically, a piecewise linear interpolation approach is employed to calibrate the correspondence between the actual target torque of the new motor and the original torque of the legacy motor. In linear interpolation, the interpolation function is a first-order polynomial (i.e., a linear function), and the interpolation error is zero at the node points. Geometrically, this means that a straight line between two adjacent torque points is used to approximate the original torque function. Through this software algorithm, the constant torque performance control of the new motor is made to substantially align with the target benchmark set by the legacy motor.

The operational principle of the software solution of the disclosure, as shown in FIG. 1, is as follows:
S1: Define a desired torque range of the legacy motor, represented by an array LUT_X[m] (where m>=3). This torque range is divided into three or more segments; a greater number of segments is beneficial for improving accuracy. The reference torque points defining these segments must include the minimum torque, the maximum torque, and the half torque of the legacy motor.
S2: For the new motor (defined as one whose performance can substantially coincide with that of the legacy motor), identify, via multi-point testing, the values at which the actual torque at m points coincides with the desired torque points. This forms a new array, represented by LUT_Y[m] (where m>=3).
S3: Upon receiving the original input target torque value T0 for the new motor, first determine to which interval of LUT_Y[m] the value T0 belongs. Then, invoke the linear interpolation module function associated with LUT_X[m] and LUT_Y[m] to obtain the new torque target value T1. By controlling the new motor with this new torque target value T1 for constant torque operation, the desired original input target torque value T0 is effectively achieved.

As shown in FIG. 1, an exemplary embodiment employing a 4-segment switching scheme, where m=5, divides the torque range of the legacy motor into four intervals:
1. Definition of General Control Parameters: Define two arrays:

LUT_X[5]={X1, X2, X3, X4, X5} represents five desired reference torque points, based on the original torque characteristics of the customer's mass-produced legacy ECM motor. These points are, for example, 1% Tmax, 30% Tmax, 50% Tmax, 70% Tmax, and 100%*Tmax, of which the minimum torque value and the maximum torque value must be included. Tmax typically denotes the rated torque of the legacy motor.

LUT_Y[5]={Y1, Y2, Y3, Y4, Y5} represents the new target torque values of the new motor after it meets the aforementioned five reference torque points. The values in LUT_Y[5] are gradually adjusted through an experimental method. This adjustment ensures that the actual torque output of the new motor at each corresponding point matches that of the legacy motor, that is, the actual torque curve at LUT_Y[5] coincides with that at LUT_X[5], LUT_Y[4] with LUT_X[4], LUT_Y[3] with LUT_X[3], LUT_Y[2] with LUT_X[2], and LUT_Y[1] with LUT_X[1]. Subsequently, the five determined new target torque values are recorded to populate the LUT_Y[5] array.
2. Piecewise Linear Interpolation: Any originally input target torque setpoint T0 will fall within one of the multiple intervals between Y1 and Y5. The specific interval in which the target torque T0 is located is determined (the range is divided into four intervals: Y1-Y2, Y2-Y3, Y3-Y4, and Y4-Y5, which are roughly equally divided based on the torque range). Linear interpolation is then performed using the segment corresponding to the identified interval.

The interpolation formulas for each segment are defined as follows:

For the 1st interval segment (where T0 falls within the interval [Y1, Y2]): Y=Y1+(Y2−Y1)/(X2−X1). Y=Y1+((Y2−Y1)/(X2−X1))*(T0−X1)

For the 2nd interval segment (where T0 falls within the interval [Y2, Y3]): Y=Y2+(Y3−Y2)/(X3−X2).

For the 3rd interval segment (where T0 falls within the interval [Y3, Y4]): Y=Y3+(Y4−Y3)/(X4−X3).

For the 4th interval segment (where T0 falls within the interval [Y4, Y5]): Y=Y4+(Y5−Y4)/(X5−X4).
3. Following the linear interpolation, a new target torque value T1 is obtained. By controlling the new motor to operate at this new torque target value T1 under constant torque control, its output substantially matches the desired original input torque value T0 of the legacy motor. The utilization of multi-segment interpolation yields a more precise target value compared to single-segment interpolation.

The constant torque calibration method for ECM motors described in this disclosure provides a simple yet effective calibration process. The method significantly reduces the cost and time associated with secondary development. Furthermore, The method effectively addresses the prevalent industry challenge of ensuring substantially consistent performance when replacing existing constant torque-controlled ECM motors with new ones in the market.

It will be obvious to those skilled in the art that changes and modifications may be made, and therefore, the aim in the appended claims is to cover all such changes and modifications.

What is claimed is:

1. A method for calibrating constant torque of an electronically commutated motor (ECM), the method being applied to replacing a legacy motor with a new motor, both the new motor and the legacy motor being constant torque-controlled ECMs, and the method for calibrating constant torque of the new motor comprising:
a) selecting m torque reference points based on torque values of the legacy motor to form a desired torque value array LUT_X[m], where m≥3, LUT_X[1] is a minimum torque value of the legacy motor, LUT_X[max(m)] is a maximum torque value of the legacy motor, m is an integer, and max(m) is a maximum value of m;
b) based on an actual torque of the new motor, identifying m torque adjustment points, wherein torque values of the torque adjustment points have a one-to-one correspondence with torque values of the torque reference points, to form a new target torque value array LUT_Y[m]; and
c) receiving an externally input target torque T0, invoking a linear interpolation module function associated with the desired torque value array LUT_X[m] and the new target torque value array LUT_Y[m] to obtain a corresponding new torque target value T1, and allowing the new motor to operate under constant torque control using the new torque target value T1.

2. The method of claim 1, wherein in c), the linear interpolation module function employs a piecewise interpolation method comprising:
c1) receiving the externally input target torque T0, comparing T0 with the torque values of the torque adjustment points, and identifying two torque adjustment points a and a+1 closest to T0, wherein a torque value of point a<T0<a torque value of point a+1, and a is an integer; and
c2) invoking the linear interpolation module function comprising LUT_Y[a], LUT_Y[a+1], LUT_X[a], and LUT_X[a+1] to obtain the new torque target value T1, and adjusting the new motor to operate at the new torque target value T1.

3. The method of claim 2, wherein the linear interpolation module function comprising LUT_Y[a], LUT_Y[a+1], LUT_X[a], and LUT_X[a+1] is T1=LUT_Y[a]+(LUT_Y[a+1]−LUT_Y[a])/(LUT_X[a+1]−LUT_X[a]).

4. The method of claim 3, wherein in b), the torque value of each torque adjustment point is adjusted via an experimental method such that the torque value of each torque adjustment point equals the torque value of its corresponding torque reference point, to form the new target torque value array LUT_Y[m].

5. The method of claim 4, wherein adjusting the torque value of each torque adjustment point is achieved by adjusting current and rotational speed parameters for that point.

6. The method of claim 1, wherein in a), when m is an odd number, the torque value of LUT_X[median(m)] is set to be half of a rated torque value of the legacy motor, and median(m) refers to a median value from 1 to m.

7. The method of claim 5, wherein in a), when m is an odd number, the torque value of LUT_X[median(m)] is set to be half of a rated torque value of the legacy motor, and median(m) refers to a median value from 1 to m.
